(19) United States
(12) Patent Application Publication
(10) Pub. No.: US 2015/0106266 A1
(43) Pub. Date: Apr. 16, 2015

(54) PLACE INFORMATION MANAGEMENT SERVER, SYSTEM, AND METHOD

(71) Applicant: ELECTRONICS AND TELECOMMUNICATIONS RESEARCH INSTITUTE, Daejeon (KR)

(72) Inventors: Seung Ik LEE, Chungcheongbuk-do (KR); Yun Kyung PARK, Daejeon (KR)

(73) Assignee: ELECTRONICS AND TELECOMMUNICATIONS RESEARCH INSTITUTE, Daejeon (KR)

(21) Appl. No.: 14/220,711

(22) Filed: Mar. 20, 2014

(30) Foreign Application Priority Data
Oct. 14, 2013 (KR) 10-2013-0122028

(51) Int. Cl. G06Q 20/40

(52) U.S. Cl. CPC G06Q 20/409
USPC 705/44

(57) ABSTRACT

Provided are a place information management server, system, and method. The place information management system includes a user terminal configured to, when a card approval message is received, extract a card approval place name included in the card approval message, and generate card approval information that includes position information and time information of when the card approval message is received and the card approval place name, and a place information management server configured to, when the card approval information is received, determine whether the card approval place name matches a place that a user of the user terminal visits, and generate and store visiting place information.

This invention can acquire not a physical position information of a user but a meaningful visiting place information in real time, and it makes a user customized marketing based on stored visiting place information could be possible.

### CROSS-REFERENCE TO RELATED APPLICATIONS

This application claims priority under 35 U.S.C. §119 to Korean Patent Application No. 10-2013-0122028, filed on Oct. 14, 2013, the disclosure of which is incorporated herein by reference in its entirety.

### TECHNICAL FIELD

The present invention relates to a place information management system and method that extract, store, and manage place information of a user, and more particularly, to a system and a method that extract and manage visiting place information of a user by using a credit card approval message received when the user uses a credit card.

### BACKGROUND

Recently, as the demand for smart devices increases explosively, a number of marketing methods based on the smart device are being proposed. In particular, since a physical position of a user is easily acquired from a sensor of a global positioning system (GPS) equipped in a smart device, marketing based on a position is provided, and the demand is exponentially increasing.

A related art position-based service is at a level of using a physical position (i.e., latitude and longitude information provided from a GPS) of a user as-is. For example, services such as navigation for smartphones, a map service, a position-based social network service (SNS), etc. use physical position information of a user as-is.

However, for marketing which is targeted in more detail, it is required to provide more meaningful information than physical position information of a user. For example, it is possible to provide marketing optimized for a corresponding place when knowing a name or classification of a place which a user visits currently.

In the related art, there is a place-based service. For example, Foursquare provides a service, based on a visiting place, but has a limitation in that a user directly inputs information about a visiting place or selects a place from a proposed place list.

In order to solve such a problem, research is being recently done for technology that builds a database of signal intensities of wireless Wi-Fi and the like in doors, and extracts indoor position determination and place information. However, the technology has a limitation in that it is required to build an infrastructure such as a wireless Wi-Fi database for buildings and a database of drawings or structures of the buildings.

The existing technology simply uses physical position information obtained from a position sensor as-is, and moreover, place-based technology has a problem in that active intervention of a user is needed or it is required to build an infrastructure.

Therefore, it is required to develop technology that automatically determines information about a visiting place of a user in real time without building an infrastructure (which expends the enormous expense) or requiring active intervention of a user, and extracts user place information based on the determined information so as to be used for marketing which is targeted in more detail.

### SUMMARY

Accordingly, the present invention provides a system and a method that verify a current visiting place of a user by using a card approval message of the user, and collect and provide information about the visiting place.

In one general aspect, a place information management server includes: a transceiver configured to receive card approval information from a user terminal, the card approval information including a card approval place name, position information, and time information; a point of interest (POI) storage unit configured to store POI information including a name of POI and position information; a place verifier configured to compare the card approval information and the POI information to verify a visiting place of the user terminal, and output visiting place information; and a storage unit configured to store the visiting place information.

The place verifier may acquire a name of POI matching the card approval place name, and determine whether the position information included in the card approval information and position information of the name of POI are within a predetermined range to verify the visiting place.

The place verifier may acquire POI information corresponding to the position information included in the card approval information, and compare a name of POI included in the acquired POI information and the card approval place name to verify the visiting place.

The place verifier may compare the card approval place name and the visiting place information stored in the visiting place storage unit, and when there is no visiting place information matching therebetween, the place verifier may compare the card approval place name and the POI information stored in the POI storage unit.

The place verifier may compare the card approval place name and an extension name of the card approval place name.

The POI storage unit may store the POI information further including place classification information of a POI, the place classification information being composed of a plurality of classes.

The visiting place storage unit may store the visiting place information, based on the POI information stored in the POI storage unit.

When the card approval information is received, the transceiver may transmit latest card approval pattern information to the user terminal.

In another general aspect, a user terminal for providing place information includes: a card approval pattern information storage unit configured to store pattern information of card approval messages by card providers; a card approval message processor configured to, when a message is received, determine whether the message is a card approval message, based on the pattern information, and when the message is the card approval message, generate card approval information; and a transceiver configured to transmit the card approval information to a place information management server.

The card approval message processor may generate card approval information that includes a card approval place name, included in the card approval message, and position information and time information of when the card approval message is received.

The card approval pattern information storage unit may update pre-stored card approval pattern information according to card approval pattern information which is received through the transceiver from the place information management server at certain intervals.

In another general aspect, a place information management system includes: a user terminal configured to, when a card approval message is received, extract a card approval place name included in the card approval message, and generate card approval information that includes position information and time information of when the card approval message is received and the card approval place name; and a place information management server configured to, when the card approval information is received, determine whether the card approval place name matches a place that a user of the user terminal visits, and generate and store visiting place information.

In another general aspect, a place information management method using a user terminal includes: receiving a message; determining whether the message is a card approval message, based on card approval pattern information; when the message is the card approval message, checking a card approval place name to generate card approval information that includes position information and time information of when the card approval message is received and the card approval place name; and transmitting the card approval information to a place information management server.

In another general aspect, a place information management method using a place information management server includes: receiving card approval information; determining whether there is place information matching a card approval place name included in the card approval information; when there is the place information matching the card approval place name, comparing position information included in the card approval information and position information of the place information to verify the place information; and when the place information is verified, storing the place information as visiting place information.

Other features and aspects will be apparent from the following detailed description, the drawings, and the claims.

### BRIEF DESCRIPTION OF THE DRAWINGS

FIG. 1 is a block diagram illustrating an overall configuration of a place information management system according to an embodiment of the present invention.

FIG. 2 is a block diagram illustrating a configuration of each of a user terminal and a place information management server that provide place information, according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

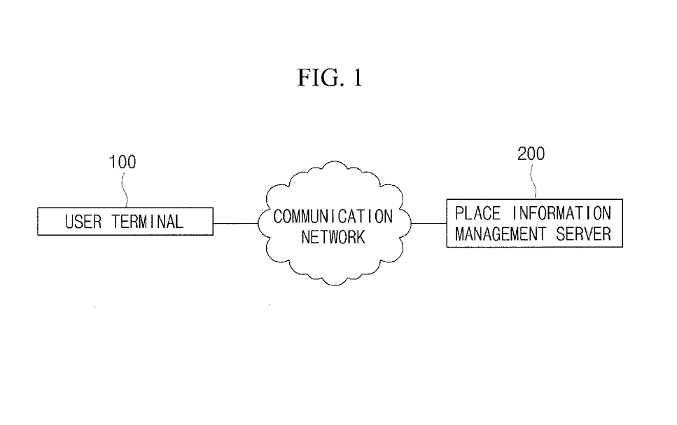

FIG. 1 is a block diagram illustrating an overall configuration of a place information management system according to an embodiment of the present invention.

The place information management system according to an embodiment of the present invention includes a user terminal 100, which receives a card approval message and collects position and time information of a user, and a place information management server 200 that receives the card approval message and the collected position and time information over a communication network to verify place information of a user, and stores, manages, and provides the place information.

The communication network uses one of all communication technologies, which enables the user terminal 100 to transmit the collected information to the place information management server 200, such as Wi-Fi, 3G, 4G, etc.

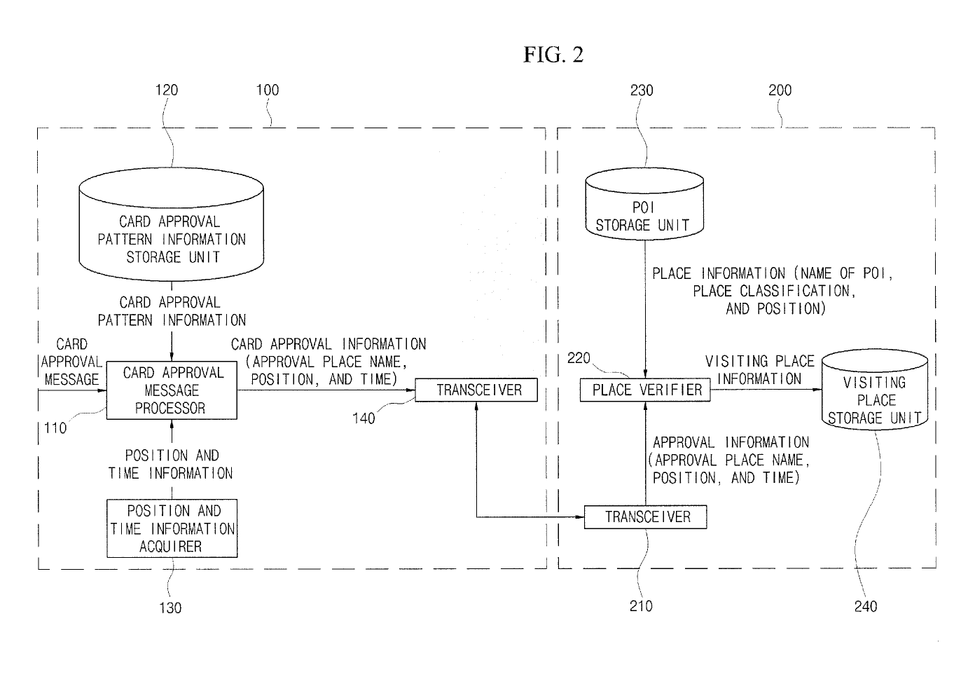

FIG. 2 is a block diagram illustrating a detailed configuration of each of the user terminal 100 and the place information management server 200 that are included in the place information management system according to an embodiment of the present invention.

The user terminal 100 providing place information includes a card approval message processor 110, a card approval pattern information storage unit 120, a position and time information acquirer 130, and a transceiver 140.

The card approval message processor 110 analyzes content of a received card approval message to extract an approval place name, integrates the approval place name with position and time information transferred from the position and time information acquirer 130 to generate card approval information, and transmits the card approval information to the place information management server 200 through the transceiver 140.

In this case, since patterns of approval messages differ by card providers, the card approval message processor 110 primarily determines whether a received message is a card approval message by using card approval pattern information predefined in the card approval pattern information storage unit 120, and when it is determined that the received message is the card approval message, the card approval message processor 110 secondarily extracts a card approval place name.

The card approval pattern information storage unit 120 receives updated card approval pattern information from the place information management server 200 at certain intervals to maintain the latest pattern information.

The position and time information acquirer 130 receives arrival notification of the card approval message from the card approval message processor 110, and acquires a time when the arrival notification is received and a position of the user terminal 100 at the time.

In order to acquire the position, the user terminal 100 may include a sensor or a module for acquiring the position of the user terminal 100, and for example, may include a GPS sensor. The card approval message arrival time may be a time acquired from the GPS sensor.

The transceiver 140 of the user terminal 100 transmits card approval information to the place information management server 200, and receives the latest card approval pattern information from the place information management server 200. The latest card approval pattern information is stored in the card approval pattern information storage unit 120.

The place information management server 200 according to an embodiment of the present invention includes a transceiver 210, a place verifier 220, a point of interest (POI) storage unit 230, and a visiting place storage unit 240.

The transceiver 210 of the place information management server 200 transfers the card approval information, received from the user terminal 100, to the place verifier 220, and transfers the latest card approval pattern information to the user terminal 100.

The place verifier 220 verifies whether an approval place name indicates a place that the user visits actually, on the basis of the card approval information (the approval place name, the position, and the time) received the user terminal 100. In this case, the place verifier 220 verifies the place by using POI information stored in the POI storage unit 230. When the approval place name indicates the place that the user visits actually, the place verifier 220 stores visiting place information in the visiting place storage unit 240.

The reason that the place verifier 220 is needed is because as card payments at Internet shopping malls and the like increase, a card approval place name cannot correspond to a place that a user visits actually. For example, when a user do Internet shopping at a coffee shop, a place name of a card approval message appears as a shopping mall operating company (for example, Interpark. Co., Ltd.), but a place that the user actually visits is the coffee shop.

According to an embodiment of the present invention, the place verifier 220 primarily searches the visiting place storage unit 240 by using the approval place name. The visiting place storage unit 240 stores a record of a previously visited place. Since a user repeatedly visits a visited place, a record of the visit is stored in the visiting place storage unit 240, and by first searching for information stored in the visiting place storage unit 240, search and verification can be performed more efficiently.

When there is a matched place as the primary search result, the place verifier 220 adds the approval place name into an approval place name list of searched visiting place information, thereby maintaining a plurality of approval place names for the same place.

When a matched visiting place is not stored in the visiting place storage unit 240 as the primary search result, the place verifier 220 secondarily searches the POI storage unit 230. When there is a matched place name as the secondary search result, the place verifier 220 is provided with corresponding POI information. Here, the POI information includes a name of POI, a position, and place classification.

When performing search by using a card approval place name, the place verifier 220 may generate a search list that includes the originally received approval place name and an extension place name thereof, and may search for each place name of the search list in the visiting place storage unit 240 or the POI storage unit 230. A method of extending a place name includes deletion of a bracket section and deletion of a blank.

For example, when Lotteria Co., Ltd. Sangam branch is the original approval place name, an extended search list includes Lotteria Co., Ltd. Sangam branch, LotteriaSangam branch, LotteriaSangambranch, and Lotteria Sangam branch. The reason that extension of a place name is needed is because card providers use various expressions for the same place, and is for solving a problem caused by the various expressions.

In verifying whether the user actually visits an approval place, the place verifier 220 compares position information (an actual position of the user terminal 100) acquired from the card approval information and position information provided from the POI storage unit 230, and when a distance between two positions is within a predetermined range, the place verifier 220 determines the user as actually visiting the approval place. When the verification of the visiting place is completed, the place verifier 220 stores visiting place information in the visiting place storage unit 240.

According to another embodiment of the present invention, the place verifier 220 may extract place information corresponding to position information included in card approval information from the visiting place storage unit 240 or the POI storage unit 230, and determine whether a name included in the extracted place information matches an approval place name included in the card approval information, thereby determining whether a user actually visits an approval place.

The POI storage unit 230 stores information about a POI. The POI includes a name of POI, a position, and place classification.

The position may include latitude and longitude coordinates, and the name of POI may be a name of a place corresponding to the position.

The place classification is information for defining a category of a place, and may be a category composed of a plurality of classes or stages. For example, in the case of a coffee shop “Caffebene”, a first-stage category may be a food item, and a second-stage category lower than the first-stage category may be a coffee shop.

The visiting place storage unit 240 stores visiting place information that is information about a place that the user of the user terminal 100 visits. The visiting place information includes a user identification (ID), a name of POI, an approval place name list, a position, a time, and place classification.

The name of POI is a name that the place verifier 220 acquires from the POI storage unit 230 so as to verify an approval place name. Generally, an approval place name may differ from a name of POI stored in the POI storage unit 230, and thus, the name of POI acquired from the POI storage unit 230 is used as a representative name of a corresponding place.

An approval place name is a name of a user visiting place received from the user terminal 100. Generally, since card providers use different place names for the same place, a name of POI is added into the approval place name list as a representative name, and an approval place name is added into the approval place name list as a nickname.

The position is a position of the POI acquired from the POI storage unit 230. The time is a time extracted from the card approval information received from the user terminal 100.

A place information management method according to an embodiment of the present invention includes: an operation in which, when the user uses a credit card at a visiting place and the card approval message arrives at the user terminal 100, the card approval message processor 110 receives the card approval message; an operation that determines whether the received card approval message is a normal card approval message; an operation that extracts an approval place name from the card approval message; an operation that acquires position and time information of the user terminal 100 at a time when the card approval message arrives; an operation that generates card approval information including an approval place name, a position, and time information; an operation in which the place verifier 220 verifies whether the approval place name included in the card approval information is a name of a place that the user actually visits; an operation that stores verified place information; and an operation that provides the stored place information to a person requiring the place information.

Advantages, obtained by applying the place information management system and method using the card approval message according to the present invention in real life, will now be described in detail.

First, the system and method according to the present invention may be applied in terms of marketing. Generally, in the existing marketing for users of mobile terminals, a relevant company provides an advertisement based on simple position information when there is a user at a near place, and thus, there is no information about a preference or a current activity of a user. For this reason, it is impossible to provide more detailed and personalized marketing.

However, by applying the system and method according to the present invention, a name and classification of a place that a user visits may be used, and thus, it is possible to provide more detailed and personalized marketing. For example, marketing for a movie that is coming soon is provided to current audiences in a cinema house, or marketing for goods relevant to a movie showing now is provided.

As another example, the system and method according to the present invention predict a place that a user, visiting a current place, will visit next, and thus provide preemptive marketing.

For example, in the case of a user having 90% or more probability that the user will go to a coffee shop after lunch as an analysis result of previously visited places, when a current visiting place is a restaurant and a current time is lunch time, satisfaction and purchasing power of the user can be maximized by providing coffee-related marketing. Also, a tendency or a pattern of each user is acquired by analyzing a previously visited history of one user and visiting histories of a plurality of users, and thus, a customized service can be provided to a user by using information about persons having the same tendency or pattern.

By applying the system and the method according to the present invention, it is possible to provide a customized service in which a detailed personal characteristic is well reflected based on a place name and place classification in comparison with the existing simple position-based service, and place information is acquired without building a separate infrastructure or requiring active intervention of a user. Accordingly, the building cost of an infrastructure is reduced, and convenience of a user increases.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A place information management server comprising:
a transceiver configured to receive card approval information from a user terminal, the card approval information including a card approval place name, position information, and time information;
a point of interest (POI) storage unit configured to store POI information including a name of POI and position information;
a place verifier configured to compare the card approval information and the POI information to verify a visiting place of the user terminal, and output visiting place information; and
a storage unit configured to store the visiting place information.

2. The place information management server of claim 1, wherein the place verifier acquires a name of POI matching the card approval place name, and determines whether the position information included in the card approval information and position information of the name of POI are within a predetermined range to verify the visiting place.

3. The place information management server of claim 1, wherein the place verifier acquires POI information corresponding to the position information included in the card approval information, and compares a name of POI included in the acquired POI information and the card approval place name to verify the visiting place.

4. The place information management server of claim 1, wherein the place verifier compares the card approval place name and the visiting place information stored in the visiting place storage unit, and when there is no visiting place information matching therebetween, the place verifier compares the card approval place name and the POI information stored in the POI storage unit.

5. The place information management server of claim 1, wherein the place verifier compares the card approval place name and an extension name of the card approval place name.

6. The place information management server of claim 1, wherein the POI storage unit stores the POI information further including place classification information of a POI, the place classification information being composed of a plurality of classes.

7. The place information management server of claim 1, wherein the visiting place storage unit stores the visiting place information, based on the POI information stored in the POI storage unit.

8. The place information management server of claim 1, wherein when the card approval information is received, the transceiver transmits latest card approval pattern information to the user terminal.

9. A user terminal for providing place information, the user terminal comprising:
a card approval pattern information storage unit configured to store pattern information of card approval messages by card providers;
a card approval message processor configured to, when a message is received, determine whether the message is a card approval message, based on the pattern information, and when the message is the card approval message, generate card approval information; and
a transceiver configured to transmit the card approval information to a place information management server.

10. The user terminal of claim 9, wherein the card approval message processor generates card approval information that includes a card approval place name, included in the card approval message, and position information and time information of when the card approval message is received.

11. The user terminal of claim 9, wherein the card approval pattern information storage unit updates pre-stored card approval pattern information according to card approval pattern information which is received through the transceiver from the place information management server at certain intervals.

12. The user terminal of claim 9, wherein when the card approval information is transmitted, the transceiver receives latest card approval pattern information from the place information management server.

13. A place information management system comprising:
a user terminal configured to, when a card approval message is received, extract a card approval place name included in the card approval message, and generate card approval information that includes position information and time information of when the card approval message is received and the card approval place name; and
a place information management server configured to, when the card approval information is received, determine whether the card approval place name matches a place that a user of the user terminal visits, and generate and store visiting place information.

14. The place information management system of claim 13, wherein the place information management server determines whether there is place information matching the card approval place name, and when there is the place information matching the card approval place name, the place information management server compares the position information included in the card approval information and position information of the place information to determine whether the card approval place name matches the place that the user visits.

15. The place information management system of claim 13, wherein when the card approval information is received, the place information management server determines whether there is visiting place information matching the card approval place name, and when there is not the visiting place information, the place information management server determines whether there is point of interest (POI) information matching the card approval place name.
